(19) United States
(12) Patent Application Publication
(10) Pub. No.: US 2009/0158529 A1
(43) Pub. Date: Jun. 25, 2009

(54) WHEELS FOR KNIVES AND SCREENING TOOLS

(76) Inventor: ED VAES, Stoney Creek (CA)

Correspondence Address: Mark A. Koch;Professional Corporation, 583 Main Street East, Hamilton, ON, L8M 1J4, CA

(21) Appl. No.: 12/333,717

(22) Filed: Dec. 12, 2008

Related U.S. Application Data
(60) Provisional application No. 61/014,872, filed on Dec. 19, 2007.

(51) Int. Cl. B26B 11/00

(52) U.S. Cl. 7/158

(57) ABSTRACT

A utility knife comprising a body, a knife blade mounted to the body, the knife blade projecting forwardly from the body; at least one split wheel mounted to a rear member portion of the body wherein the split wheel including a disc shaped left half and right half each having a chamfered outside diameter; wherein the split wheel selectively moveable between a convex configuration, and a concave configuration. Further the left half and the right half each including a small side and a large side such that the wheel placed in the convex configuration when the large sides are brought into contact with each other and the wheel placed in the concave configuration when the small sides are brought into contact with each other.

The present application claims the benefit of previously filed U.S. Provisional Application 61/014,872 filed Dec. 19, 2007 under the title WHEELS FOR KNIVES AND SCREENING TOOLS by Ed Vaes.

### FIELD OF THE INVENTION

The present invention relates to utility knives and screening tools and more particularly relates to wheels attached to utility knives and screening tools.

### BRIEF DESCRIPTION OF THE DRAWINGS

The present invention will now be described by way of example only with reference to the following drawings in which:

FIG. 1 is a left side plan view of a utility knife.

FIG. 2 is a right side plan view of a utility knife.

FIG. 3 is a rear elevational view of the utility knife shown in FIG. 1 with a convex configured wheel.

FIG. 4 is a rear elevational view of the utility knife shown in FIG. 1 with a concave configured wheel.

FIG. 5 is a rear elevational view of the utility knife shown in FIG. 1 with a double point configured wheel.

FIG. 6 is a front schematic perspective view of the screen utility knife having a split wheel and a knife blade.

FIG. 7 is a front perspective schematic diagram of an extendable screen utility knife shown in the retracted position.

FIG. 8 is a front schematic perspective view of a screen utility knife shown in an extended position.

FIG. 9 is a screen utility knife shown in the retracted position with the alternate knife blade arrangement.

FIG. 10 shows a concave configuration of the split wheels mount which can be mounted onto the screen utility knife above.

FIG. 11 is a convex configuration split wheel for mounting onto the screen utility knife.

FIG. 12 is a double point configured split wheel for mounting onto the screen utility knife.

FIG. 13 is a rear schematic perspective partial cut away view of the rear member of the screen utility knife showing the fastener removal for the split wheel.

FIG. 14 is a rear elevational schematic view of the screen utility knife showing the split wheel in a convex configuration.

FIG. 15 is a rear elevational schematic view of the screen utility knife showing the split wheel in a concaved configuration.

FIG. 16 is a rear elevational schematic view of the screen utility knife showing the split wheel confirmed in the double point configuration.

FIG. 17 is a front schematic perspective view of a rotating wheel structure showing two wheels attached via a link.

FIG. 18 is a utility screen knife having a modified rear portion including the rotating wheel structure shown in FIG. 17.

FIG. 19 is an upright schematic perspective view of a single ended screen roller showing with a quick release mechanism for the roller.

FIG. 20 is a top schematic perspective view of a spike roller.

FIG. 21 is a top schematic perspective view of a chamfered roller.

FIG. 22 is a top schematic perspective view of a stepped roller.

FIG. 23 is a top schematic perspective view of a convex roller.

FIG. 24 is a top schematic perspective view of a concaved roller.

FIG. 25 is a side elevational perspective view of a spike roller.

FIG. 26 is a side elevational perspective view of a chamfered roller.

FIG. 27 is a side elevational perspective view of a stepped roller.

FIG. 28 is a side elevational perspective view of a convex roller.

FIG. 29 is a side elevational perspective view of a concave roller.

FIG. 30 is a side elevational perspective view of a round roller.

FIG. 31 is a schematic top perspective view of a double ended screen roller showing roller mounted onto each end.

FIG. 32 is an upright perspective schematic drawing of a screen roller with a split roller showing a concaved wheel attached thereto.

FIG. 33 is an upright perspective schematic drawing of a screen roller with a split roller showing a convex roller attached thereto.

FIG. 34 shows the split wheel configuration for a concave wheel.

FIG. 35 shows configuration of the wheel for a convex wheel.

### DETAILED DESCRIPTION OF THE PREFERRED EMBODIMENT

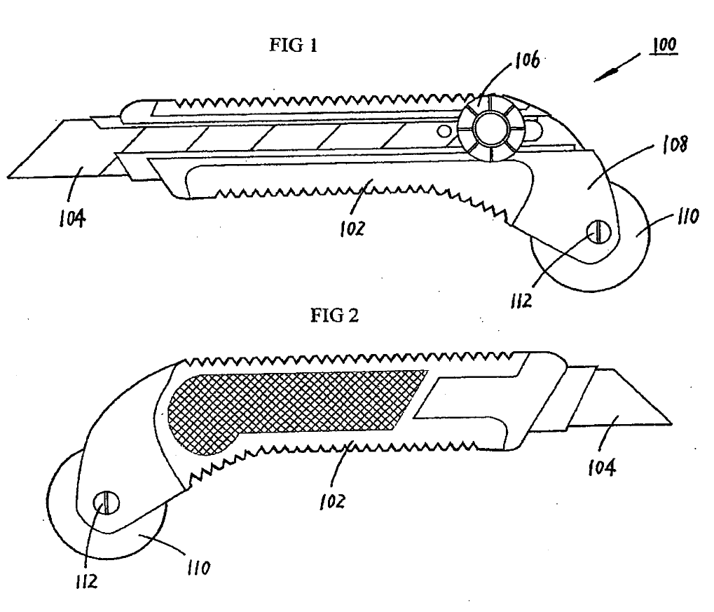

The present device, a utility knife includes a body 102 having a knife blade 104 mounted therein which is locked with a locking wheel 106. Utility knife 100 also includes a rear downwardly projecting member 108 which includes a split wheel 110 mounted thereon with fastener 112. FIG. 1 shows the left side elevational view of the utility knife, whereas FIG. 2 shows the right side elevational view of the same knife.

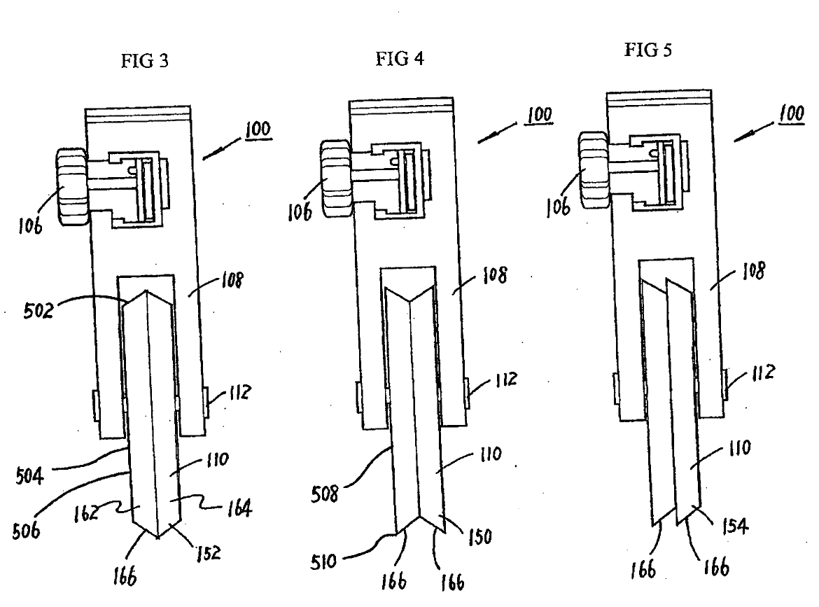

FIGS. 3, 4 and 5 show the various configurations for split wheel 110. Split wheel 110 is made in two halves such that when the wheel is dismounted from rear member 108 by releasing fastener 112, one can separate left half 162 from right half 164 and place the two halves into the convex configuration 152 as shown in FIG. 3. Each half wheel having a chamfered end 166 thereby creating a convex and/or pointed configuration as depicted in FIG. 3.

By separating the two halves, one can place left half 162 and right half 164 into concave configuration 150 by orienting the chamfered ends 166 as shown in FIG. 4.

By reorienting and separating the two halves 162 and 164, one can place the wheel halves into the double point configuration 154 by placing the chamfered ends 166 into the orientation as shown in FIG. 5.

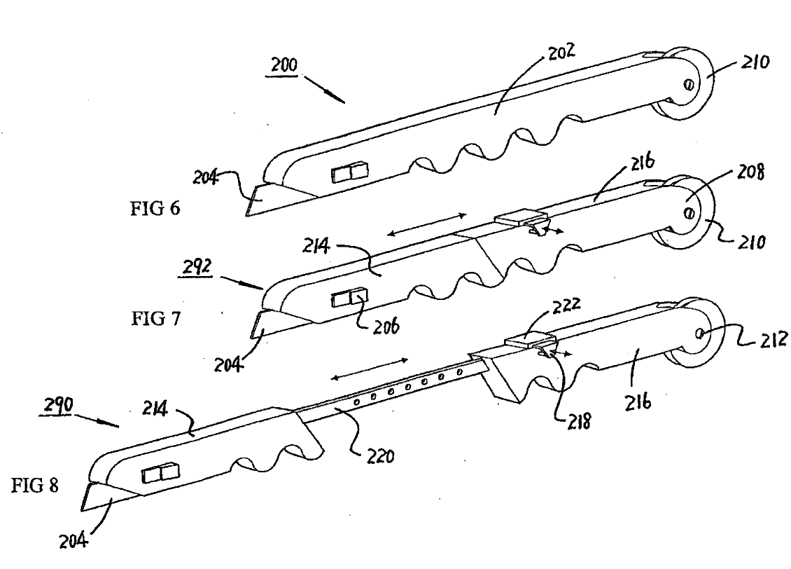

The split wheel configuration described above for utility knife 100 is also applicable to screen utility knife 200 as shown in FIGS. 6 through 16. Screen utility knife 200 includes body 202, having a knife blade 204 mounted thereon which can be locked with locking button 206. Body 202 further includes a rear downwardly projecting member 208 which has mounted thereon split wheel 210 with fastener 212. In FIGS. 7 and 8, body 202 can be split into a forward portion 214 and a rear portion 216 which can be separated and/or moved longitudinally relative to each other along extension rail 220 wherein the two body portions can be moved from a retracted position 292 shown in FIG. 7 to an extended position 290 shown in FIG. 8. In this manner, screen utility knife 200 can be extended in telescoping fashion between the retracted position 292 and the extended position 290 as shown in the FIGS. 7 and 8.

FIG. 9 is a similar screen utility knife as knife 200 shown in FIGS. 6, 7 and 8 other than a revised or alternate knife blade 230 configuration.

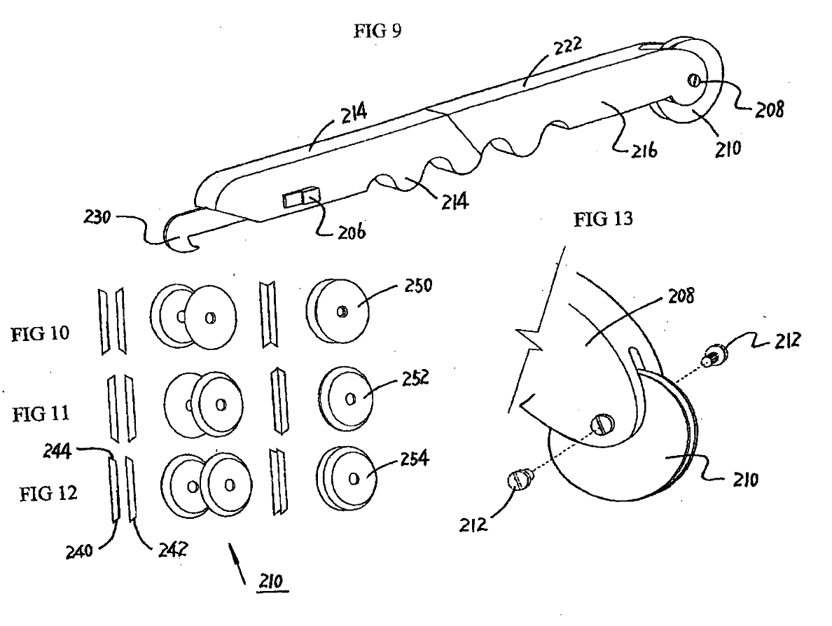

Split wheel 210 again is split into left side 240 and right side 242, each half having a chamfered surface 244 shown in FIGS. 10, 11 and 12. In FIG. 10 the wheel halves are shown in the concave configuration 250 and FIG. 11 the wheel halves are shown in the convex configuration 252 and in FIG. 12 the wheel halves are shown in the double point configuration 254. A partial cut away schematic perspective view of the rear member 208 of screen utility knife 200 is shown in FIG. 13, wherein wheel 210 can be removed by removing fastener 212 from the rear portion thereby reorienting the halves of split wheel 210.

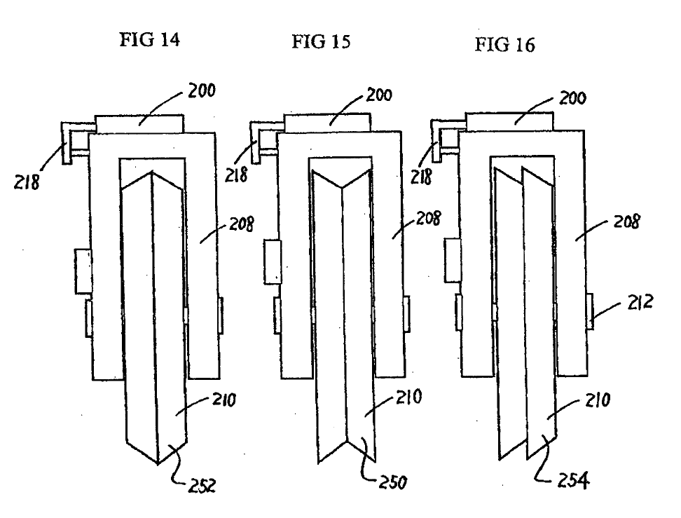

FIG. 14 shows enlarged the rear portion of screen utility knife 200 showing the wheel in a convex configuration 252 and in a concave configuration 250 and a double pointed configuration 254.

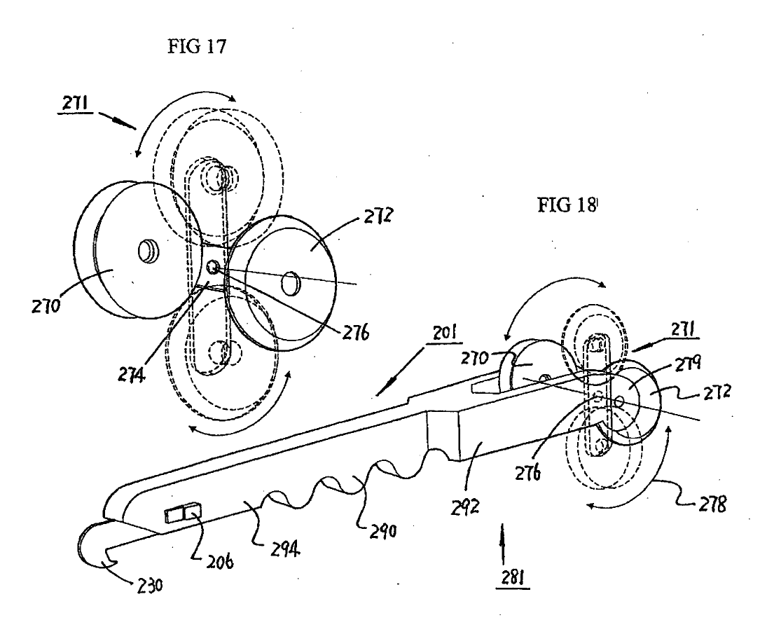

FIG. 17 shows a rotating wheel structure 271 which includes a convex wheel 272 mounted at one end to a link 274 and a concave wheel 270 mounted at the other end of the link. The link pivots about a pivot point 276 which can be mounted to a rear member 279 to screen tool 281. One can pivot link 274 in the circular direction as shown as 278 in FIG. 18, thereby selecting either a convex wheel 272 or a concaved wheel 270 as required. Screen tool 281 includes a body 290, a forward portion 294, a rear portion 292, and a knife blade 230 and functions similarly to screen utility knife 200 described above. The major difference between screen tool 281 and screen utility knife 200 is the modified forked rear portion 292 for mounting of rotating wheel structure 271 thereon, thereby including a pivoting wheel selection system which allows one to selectively choose a different wheel configuration.

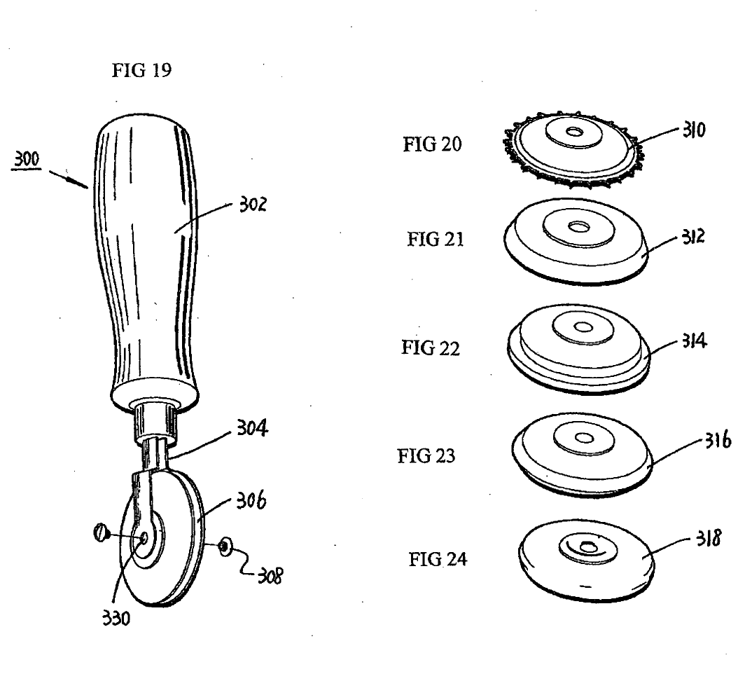

Referring now to FIG. 19 which depicts a single ended screen roller having a body 302, a roller frame 304, a roller 306, a quick release mechanism 308 for quickly attaching and detaching roller 306. Roller 306 and roller frame 304 both include an aperture 330, through which quick release mechanism 308 is mounted.

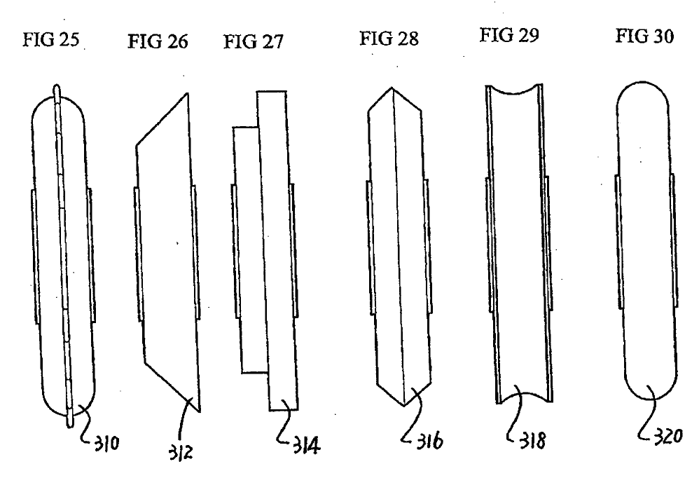

In this manner, single ended screen roller 300 could be sold and accessorized with wheels of various configuration such as a spike roller 310, chamfered roller 312, a step roller 314, a convex roller 316 and a concave roller 318. These rollers are also depicted in FIGS. 25 to 30 and FIG. 30 in particular also shows a round roller 320 as well. For a singled ended screen roller 300 a quick release mechanism is used in order to mount and dismount the various wheel configurations onto and off of roller frame 304. Therefore, one can select the appropriate wheel for the function required and attach the wheels to the roller frame 304.

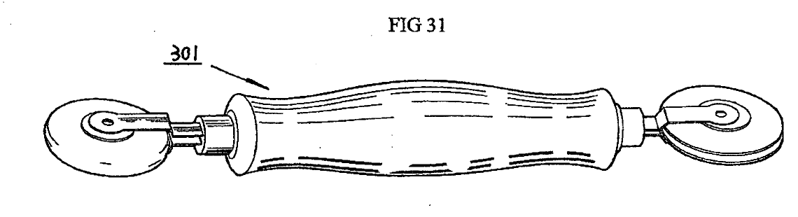

FIG. 31 shows a double ended screen roller 31 which again could be fitted with a quick release mechanism 308 not shown in similar fashion as shown in FIG. 19. In this manner differently configured rollers could be attached and/or detached from both ends of double ended screen roller 301 in similar fashion as described above for single ended screen roller 300.

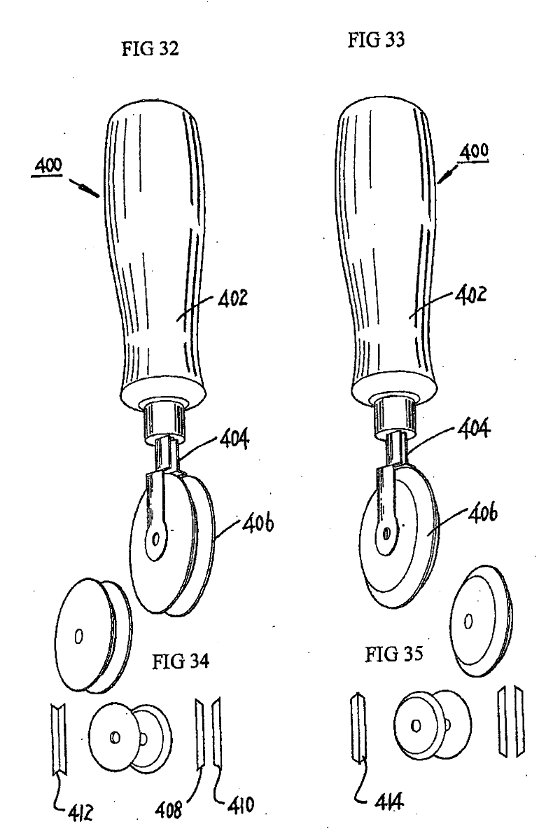

FIGS. 32 and 33 show screen roller 400 having a body 402, roller frame 404 and a split roller 406. In FIG. 32, split roller 406 is shown in the concave configuration 412 and in FIG. 33, split roller is shown in the convex configuration 414. The roller could also be placed into the double point configuration as shown in FIG. 5, but not depicted in these diagrams.

The drawings also do not show a quick release mechanism, however one could be added for connecting roller frame to a split roller in similar fashion as quick release mechanism 308 as shown in FIG. 19. In this manner the roller halves could be disconnected quickly from screen roller 400, such that left side 408 and right side 410 could be placed in the various configurations as depicted in 34 and 35 as well as in FIG. 5.

It should be apparent to persons skilled in the arts that various modifications and adaptation of this structure described above are possible without departure from the spirit of the invention the scope of which defined in the appended claim.

I claim:

1. A utility knife comprising:
a) a body;
b) knife blade mounted to the body, the knife blade projecting forwardly from the body;
c) at least one split wheel mounted to a rear member portion of the body;
d) the split wheel including a disc shaped left half and right half each having a chamfered outside diameter;
e) wherein the split wheel selectively moveable between a convex configuration, and a concave configuration.

2. The utility knife claimed in claim 1 wherein the left half and the right half each including a small side and a large side such that the wheel placed in the convex configuration when the large sides are brought into contact with each other and the wheel placed in the concave configuration when the small sides are brought into contact with each other.

3. The utility knife claimed in claim 1 further including a means for quick release for mounting and dismounting the split wheel from the body.

4. The utility knife claimed in claim 1 wherein the quick release means including a thumb screw for mounting and dismounting the split wheel from the body.

5. The utility knife claimed in claim 1 wherein the split wheel further selectively moveable into a double point configuration.

6. The utility knife claimed in claim 1 wherein the double point configuration a small side of one half is brought together with the large side of the other half.

7. The utility knife claimed in claim 1 wherein the blade is extending from end of the body and the split wheel projecting from the other end of the body.

8. The utility knife claimed in claim 1 including a means for selectively extending the length of the body such that the body moveable between a retracted position and extended position.

9. The utility knife claimed in claim 8 wherein the extending means including an extension rail telescopically mounted within a forward portion and rear portion of the body.

10. A screen roller comprising:
a) a body;
b) roller frame mounted to the body, the roller frame projecting forwardly from the body;
c) at least one split wheel mounted to the roller frame;
d) the split wheel including a disc shaped left half and right half each having a chamfered outside diameter;
e) wherein the split wheel selectively moveable between a convex configuration, and a concave configuration.

11. The screen roller claimed in claim 10 wherein the left half and the right half each including a small side and a large side such that the wheel placed in the convex configuration when the large sides are brought into contact with each other and the wheel placed in the concave configuration when the small sides are brought into contact with each other.

12. The screen roller claimed in claim 10 further including a means for quick release for mounting and dismounting the split wheel from the body.

13. The screen roller claimed in claim 12 wherein the quick release means including a thumb screw for mounting and dismounting the split wheel from the body.

14. The screen roller claimed in claim 10 wherein the split wheel further selectively moveable into a double point configuration.

15. The screen roller claimed in claim 1 wherein the double point configuration a small side of one half is brought together with the large side of the other half.
